(19) United States
(12) Patent Application Publication
(10) Pub. No.: US 2014/0352991 A1
(43) Pub. Date: Dec. 4, 2014

(54) ADJUSTABLE GAUGE WHEEL ARM

(71) Applicant: AGCO CORPORATION, Duluth, GA (US)

(72) Inventors: Ranjit Patwardhan, Hesston, KS (US); Monte Rans, Hesston, KS (US)

(21) Appl. No.: 14/369,272

(22) PCT Filed: Dec. 26, 2012
(86) PCT No.: PCT/US2012/071601

§ 371 Date: Jun. 27, 2014

Related U.S. Application Data
(60) Provisional application No. 61/580,343, filed on Dec. 27, 2011.

(51) Int. Cl. A01C 7/20

(52) U.S. Cl. CPC A01C 7/203
USPC 172/773; 29/428

(57) ABSTRACT

A planter may be disclosed, the planter may comprise a gauge wheel arm, a rod, and a bushing. The gauge wheel arm may comprise a wall defining a through bore. The rod may comprise a first end and a second end. The first end may comprise a male threaded portion. The bushing may pass through the through bore and comprise a female threaded portion coupled to the male threaded portion.

### CROSS REFERENCE TO RELATED APPLICATIONS

This application claims priority to U.S. Provisional Application No. 61/580,343 filed Dec. 27, 2011, entitled “ADJUSTABLE GAUGE WHEEL ARM”.

### BACKGROUND OF THE INVENTION

1. Field of Invention

This invention relates generally to agricultural planters, and more particularly to a planter having an adjustable gauge wheel.

2. Description of Related Art

Planters with a plurality of seed meters may plant seeds upon or in the ground at various depths and spacings. The seeds are singulated and metered by a seed metering disc with pockets, holes, or combinations thereof.

### SUMMARY OF THE INVENTION

In one embodiment, the invention relates to a planter having a gauge wheel arm, a rod, and a bushing. The gauge wheel arm may comprise a wall defining a through bore. The rod may comprise a first end and a second end. The first end may comprise a male threaded portion. The bushing may pass through the through bore and comprise a female threaded portion coupled to the male threaded portion.

Yet another embodiment may comprise a method. The method may comprise: passing a bushing through a gauge wheel arm, the bushing having head portion and a female threaded portion passing through the bushing; securing the bushing to the gauge wheel arm with a retaining ring; passing a rod having a male threaded portion through the female threaded portion; and locking the gauge wheel arm in a first position along the rod without using shims. In addition, the method may further comprise locking the gauge wheel arm in a second position along the rod without using shims.

These and other features and advantages of this invention are described in, or are apparent from, the following detailed description of various example embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is a diagram of a single row planter;

FIG. 2 is an exploded assembly of an adjustable gauge wheel arm;

FIG. 3 is a section drawing of the adjustable gauge wheel arm of FIG. 2.

FIG. 4 is an exploded assembly of another embodiment of an adjustable gauge wheel arm; and

FIG. 5 is a section drawing of the adjustable gauge wheel arm of FIG. 4.

Corresponding reference characters indicate corresponding parts throughout the views of the drawings.

### DETAILED DESCRIPTION OF EXAMPLE EMBODIMENTS

The following description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following example embodiments do not limit the disclosure. Instead, the proper scope is defined by the appended claims.

Planters may be used within an agricultural environment to facilitate placing seed and fertilizer in the ground. The planter may be connected to a tractor and have seed/fertilizer hoppers. The planter may create a furrow for the seed/fertilizer. The planter may use gauge wheels to set the depth of the furrow. After the seed or fertilizer is placed in the furrow, the planter may close the furrow with closing wheels.

While the drawings illustrate and the specification describes certain embodiments, it is to be understood that such disclosure is by way of example only. There is no intent to limit the principles disclosed to the particular disclosed embodiments. References hereinafter made to certain directions, such as, for example, “front” and “rear” are made as viewed from the side of a planter.

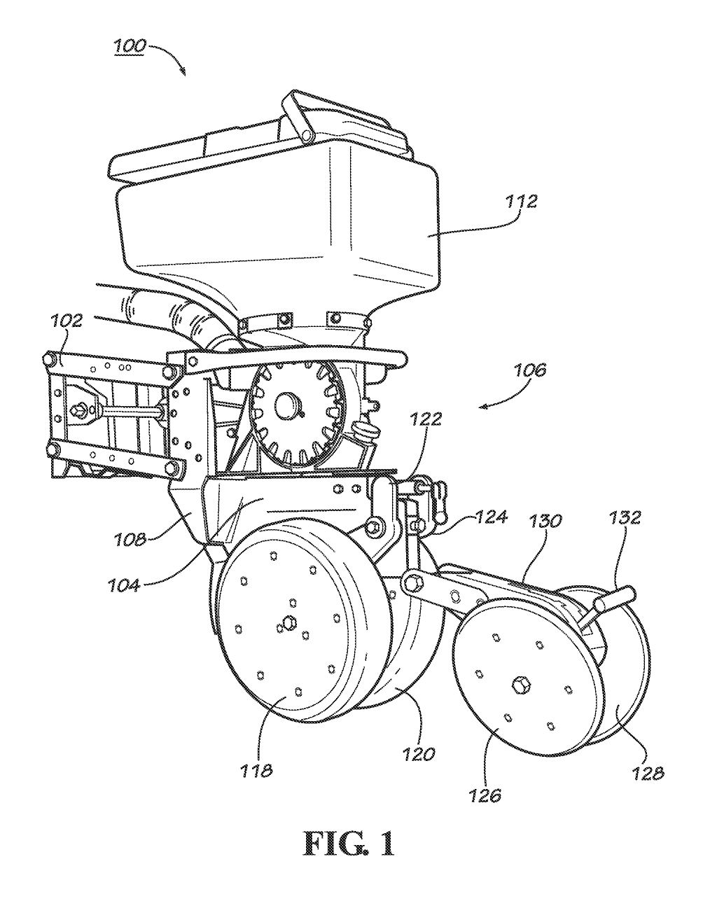

FIG. 1 illustrates a planter 100. Planter 100 may be a single row planter adapted for mounting on a hitch of a tractor or may comprise a pull-type implement with its own set of transport wheels. Planter 100 may include some suitable attachment mechanism for attaching it to a tool bar (not shown). An example of such an attachment mechanism comprises a four-bar linkage 102 and a pair of U-bolts (not shown) for fastening linkage 102 to the tool bar. Planter 100 may comprise a frame 104 attached to and projecting rearwardly from linkage 102. Frame 104 may comprise a number of components mounted thereon as hereinafter explained.

As shown in FIG. 1, planter 100 may include frame 104 and an input meter 106 attached to the frame 104. The planter 100 may include a horse collar 108 for further securing planter 100 to the tool bar and for protecting meter 106. Planter 100 may be powered or driven by individual mechanical, electrical, hydraulic or pneumatic motors. One or more planters 100 may be driven by a common motor. For example, planter 100 may be powered by a hydraulic drive or motor that powers a main line shaft of planter 100. Alternatively, planter 100 may be driven by a transmission where planter 100's wheels contacting the ground drive the main line shaft.

For each meter 106, the frame 104 of planter 100 may carry a generally upright dispensing tube 110 and may be adapted for receiving inputs such as seeds from meter 106. Meter 106 may receive seeds from a source of supply, such as a seed box or hopper 112 that may also be mounted on frame 104. Seeds that are received by meter 106 from hopper 112 may be singulated and dropped through dispensing tube 110 for deposit into the ground as planter 100 advances.

As is known in the art, a suitable furrow opener (not shown) may also be carried by frame 104 for opening a furrow in the soil for receiving seeds dropped through a dispensing tube. The furrow opener may take a variety of different forms. For example, the furrow opener may take the form of a double-disc opener having a pair of downwardly and slightly forwardly converging discs rotatably mounted on frame 104. The dispensing tube may project downwardly between the pair of discs and may have a lower discharge end facing generally rearwardly and downwardly to discharge the seeds into the furrow.

A first gauge wheel 118 and a second gauge wheel 120 may be disposed on opposite sides and may be rotatably mounted on frame 104, via a first gauge wheel arm assembly 122 and a second gauge wheel arm assembly 124, and may provide support for frame 104. The first and second gauge wheels 118, 120 may limit the depth of penetration of the furrow opener into the ground. Frame 104 may swing up and down relative to the tool bar via a four-bar linkage 102, and the downward movement may be limited by first and second gauge wheels 118, 120 as they roll along the ground. A pair of closing wheels 126 and 128 may be attached to the rear of frame 104 and may function to close the seed furrow after seeds have been deposited therein by dispensing tube 110. First and second closing wheels 126, 128 may be attached to planter 100 by a second frame 130. The vertical position of first gauge wheel 118 and second gauge wheel 120 relative to frame 104 and the furrow opener may be adjusted.

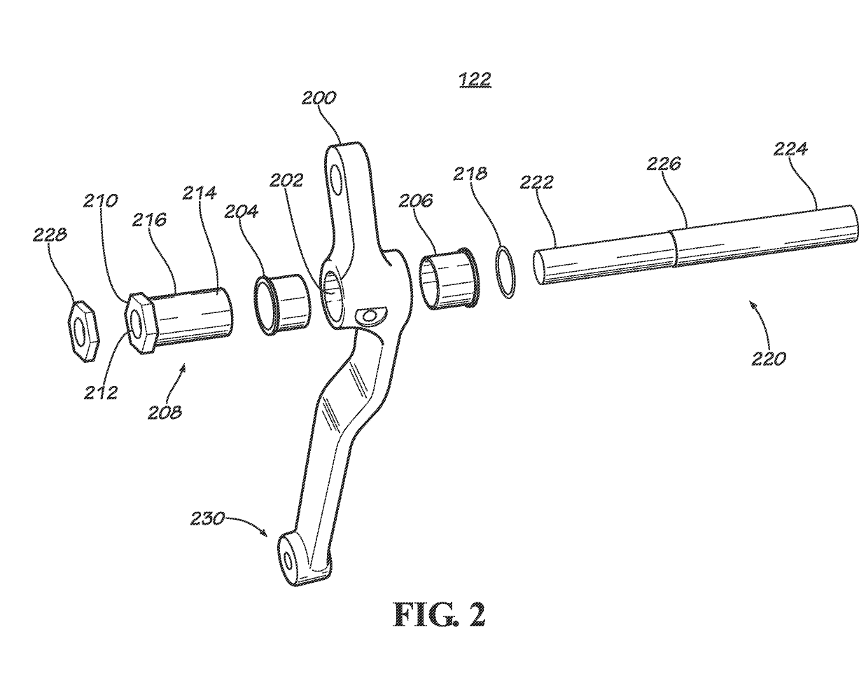

Turning now to FIG. 2, an exploded view of the first gauge wheel arm assembly 122 is illustrated. The first gauge wheel arm assembly 122 comprises a gauge wheel arm 200 having a transverse through bore 202 formed therein. A first bearing 204 and a second bearing 206 are press-fitted into the through bore 202.

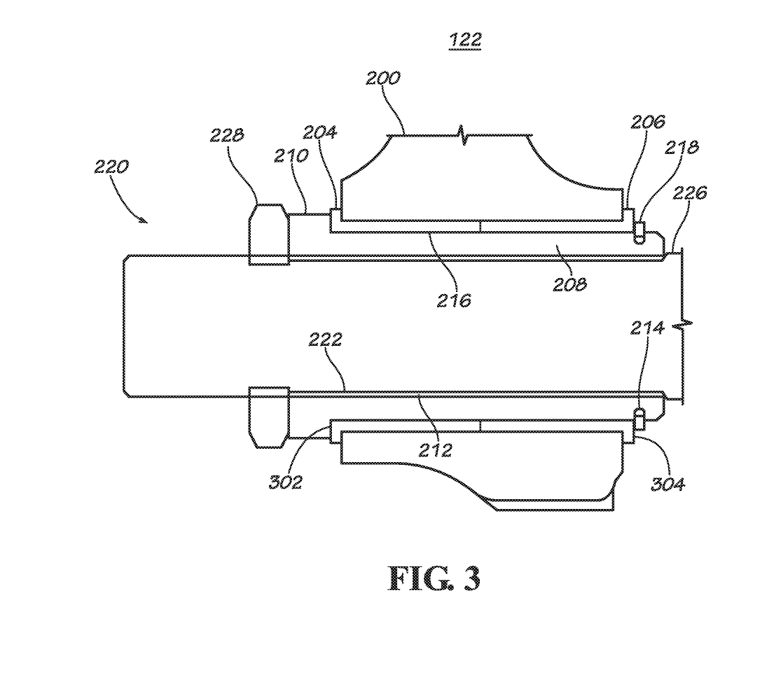

A hex-head bushing 208 passes through first gauge wheel arm 200 by passing through the first bearing 204 and second bearing 206. Hex-head bushing 208 may comprise a head portion 210 at one end of the bushing 208, a female threaded internal bore 212 extending the length of the bushing 208, an external circumferential groove 214 at the opposite end of the bushing, and a smooth surface 216. Hex-head bushing 208 may rotate freely when passing through and seated within first bearing 204 and second bearing 206. The first gauge wheel arm 200 desirably is secured on the hex-head bushing 208 by a retaining ring 218 that may be located in groove 214. As shown in FIG. 3, head portion 210 may mate with a first surface 302 of first bearing 204 and retaining ring 218 may mate with a second surface 304 of second bearing 206 to hold the first gauge wheel arm 200 on the hex-head bushing 208.

A rod 220 extending through the frame 104 (FIG. 1) may comprise a first threaded portion 222, a second threaded portion 224, and a middle portion 226. First threaded 222 and second threaded portion 224 may each comprise male threads. The first threaded portion 222 may screw into female threaded portion 212 of the hex-head bushing 208. Upon positioning the hex-head bushing in a desired location (e.g., a desired distance from middle portion 226), the first gauge wheel arm 200 may be secured in a fixed position by cinching a jam nut 228 against head portion 210 to keep the hex-head bushing 208 from rotating on the rod 220. For example, the hex-head bushing 208 may be screwed onto rod 220 to a desired position and then jam nut 228 may be tightened against head portion 210 to secure first gauge wheel arm 200 in a fixed position along the axis of rotation of the rod 220. The first gauge wheel 118, which may be attached to first gauge wheel arm 200 at lower portion 230, is thereby located a desired distance from the frame 104.

The use of the hex-head bushing 208 and rod 220 allows the position of the first gauge wheel arm 200 to be adjusted with respect to the frame 104 without the use of shims or other spacing devices. For example, instead of spacing first gauge wheel arm 200 the desired distance from center portion 226 with shims located against second surface 304, cinching jam nut 228 and hex-head bushing 208 together may act to hold first gauge wheel arm 200 in the desired position without using shims. In addition, during operation, a user may loosen jam nut 228, reposition the hex-head bushing 208, and recinch jam nut 228 to relocated first gauge wheel arm 200 in a new location. This repositioning of first gauge wheel arm 200 may be accomplished without the use of shims; thus simplifying operations and minimizing parts and tools the user may need.

FIGS. 2 and 3 have been described with respect to the first gauge wheel arm 200 attached to first threaded portion 222 of the rod 220. Embodiments may include a second gauge wheel arm assembly 124 attached to the second threaded portion 224 substantially as described above and would be understood by one skilled in the art.

Therefore, additional detail of the second gauge wheel arm assembly 124 need not be discussed herein. In addition, more than one gauge wheel arm or other implements may be attached to first threaded portion 222 and/or second portion 224. When two or more gauge wheel arms or other implements are attached to rod 220, each may be repositioned independently of one another. For example, first gauge wheel arm assembly 122 may be repositioned while the position of second gauge wheel arm assembly 124 is not disturbed.

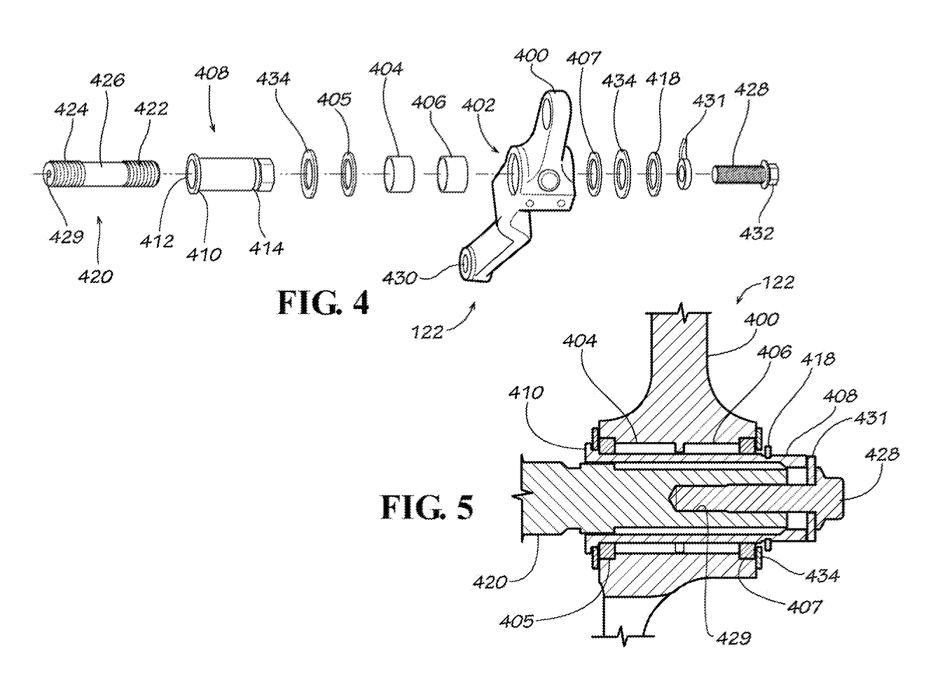

Turning now to FIGS. 4 and 5, another embodiment of the first gauge wheel arm assembly 122 is illustrated. The first gauge wheel arm assembly 122 comprises a gauge wheel arm 400 having a transverse through bore 402 formed therein. First and second bearings 404, 406 and first and second seals 405, 407 are press-fitted into the through bore 402.

An internally threaded hex-head bushing 408 passes through the first gauge wheel arm 400. The hex-head bushing 408 may comprise a head portion 410 at one end of the bushing 408, a female threaded interior bore 412 extending the length of the bushing 408, and a circumferential exterior groove 414 at an opposite end of the bushing 408. The hex-head bushing 408 is configured to be received by the first and second bearings 404, 406 and may rotate freely when passing through and seated within first and second bearings 404, 406.

A rod 420 extending through the frame 104 (FIG. 1) comprises a first externally threaded portion 422 at one end, a second externally threaded portion 424 at the opposite end, and a middle portion 426. The female threaded internal bore 412 of the hex-head bushing 408 is threaded onto the male threaded first portion 422 of the rod 420. Upon positioning the hex-head bushing 408 to position of the first gauge wheel arm 400 in a desired location (e.g., a desired distance from middle portion 426), the hex-head bushing may be secured in position. A jam bolt 428 is screwed into a female bore 429 of the rod 420 against the distal end of the hex-head busing 408 preventing the hex-head bushing from rotating on the rod 420. Desirably, a suitable washer 431 is positioned between a head 432 of jam bolt 428 and the end of the hex-head busing 408. In operation, the hex-head bushing 408 may be screwed onto the rod 420 to a desired position and then jam bolt 428 may be tightened against the hex-head bushing 408 to secure first gauge wheel arm 400 in a fixed position along the axis of rotation of the rod 420. The first gauge wheel 118 (FIG. 1), which is attached to the gauge wheel arm 400 at lower portion 430, is thereby fixedly located the desired distance from frame 104.

The first gauge wheel arm 400 desirably is secured on the hex-head bushing 408 by a retaining ring 418 that may be located in groove 414 of the bushing 408. Suitable washers 434 may be used between the head 410 of the hex head bushing 408 and retaining ring 418 and the first gauge wheel arm 400.

The positioning of the hex-head bushing 408 along rod 420 and securing the first gauge wheel arm 400 on the bushing 408 allows the position of the first gauge wheel arm 400 to be adjusted without the use of shims or other spacing devices. For example, instead of spacing first gauge wheel arm 400 the desired distance from center portion 426 with shims located against gauge wheel arm 400, screwing the hex-head bushing 408 in or out on the rod 420 may act to hold first gauge wheel arm 400 in the desired position without using shims. In addition, during operation, a user may loosen jam bolt 428, reposition first gauge wheel arm 400 by moving the hex head bushing 408 along the rod 420, and recinch jam bolt 428 to relocated first gauge wheel arm 400 in a new location. This repositioning of first gauge wheel arm 400 may be accomplished without the use of shims; thus simplifying operations and minimizing parts and tools the user may need.

Desirably, the diameter of the washer 431 and jam bolt 428 is equal to or less than the diameter of the hex head bushing 408. This allows quick assembly and removal of the gauge wheel arm assembly 122 and gauge wheel 118 for a maintenance purpose. Once the retaining ring 418 is removed, the gauge wheel arm 400 comes off without disturbing the position hex head bushing 408, and thus the gauge wheel setting, with respect to the center portion 426 of the rod 420 and the disc openers 114, 116.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. An apparatus comprising:
a gauge wheel arm comprising a wall defining a through bore;
a rod comprising a first end and a second end, the first end comprising a male threaded portion; and
a bushing passing through the through bore, the bushing comprising a female threaded portion coupled to the male threaded portion.

2. The apparatus of claim 1, wherein the bushing and the rod are configured to adjust a position of the gauge wheel arm along the rod without utilizing shims.

3. The apparatus of claim 1, wherein the bushing further comprises a head portion proximate the first end.

4. The apparatus of claim 1, further comprising a jam nut connected to the male threaded portion proximate the first end and in contact with the bushing.

5. The apparatus of claim 1, further comprising a retaining ring, wherein the bushing further comprises a groove, the retaining ring located at least partially within the groove.

6. The apparatus of claim 1, further comprising:
a jam nut; and
a retaining ring,
wherein the bushing further comprises a head portion and a groove,
wherein the jam nut is connected to the male threaded portion proximate the first end and in contact with the bushing, and
wherein the retaining ring is located at least partially within the groove.

7. The apparatus of claim 6, wherein the head portion and the jam nut are configured to allow the gauge wheel arm to be repositioned along an axis of rotation of the rod without using shims.

8. The apparatus of claim 1, wherein the gauge wheel arm is a first gauge wheel arm, the bushing is a first bushing, and the rod further comprises a second male threaded portion proximate the second end, the apparatus further comprising:
a frame comprising a first side and a second side, the first gauge wheel arranged proximate the first side;
a second gauge wheel arm arranged proximate the second side; and
a second bushing comprising a second female threaded portion passing through the second gauge wheel arm, the second female threaded portion coupled to the second male threaded portion proximate the second end.

9. The apparatus of claim 8, wherein a position of the first gauge wheel arm is configured to be adjust independent of a position of the second gauge wheel arm.

10. An apparatus comprising:
a planter comprising:
a gauge wheel arm comprising a wall defining a through bore;
a rod comprising a first end and a second end, the first end comprising a male threaded portion; and
a bushing passing through the through bore, the bushing comprising a female threaded portion coupled to the male threaded portion.

11. The apparatus of claim 10, wherein the bushing and the rod are configured to adjust a position of the gauge wheel arm along the rod without utilizing shims.

12. The apparatus of claim 10, wherein the bushing further comprises a head portion proximate the first end.

13. The apparatus of claim 10, further comprising a jam nut connected to the male threaded portion proximate the first end and in contact with the bushing.

14. The apparatus of claim 10, further comprising a retaining ring, wherein the bushing further comprises a groove, the retaining ring located at least partially within the groove.

15. The apparatus of claim 10, further comprising:
a jam nut; and
a retaining ring,
wherein the bushing further comprises a head portion and a groove,
wherein the jam nut is connected to the male threaded portion proximate the first end and in contact with the bushing, and
wherein the retaining ring is located at least partially within the groove.

16. The apparatus of claim 15, wherein the head portion and the jam nut are configured to allow the gauge wheel arm to be repositioned along an axis of rotation of the rod without using shims.

17. The apparatus of claim 10, wherein the gauge wheel arm is a first gauge wheel arm, the bushing is a first bushing, and the rod further comprises a second male threaded portion proximate the second end, the apparatus further comprising:
a frame comprising a first side and a second side, the first gauge wheel arranged proximate the first side;
a second gauge wheel arm arranged proximate the second side; and
a second bushing comprising a second female threaded portion passing through the second gauge wheel arm, the second female threaded portion coupled to the second male threaded portion proximate the second end.

18. The apparatus of claim 17, wherein a position of the first gauge wheel arm is configured to be adjust independent of a position of the second gauge wheel arm.

19. A method comprising:
passing a bushing through a gauge wheel arm, the bushing having head portion and a female threaded portion passing through the bushing;
securing the bushing to the gauge wheel arm with a retaining ring;
passing a rod having a male threaded portion through the female threaded portion; and
locking the gauge wheel arm in a first position along the rod without using shims.

20. The method of claim 19, further comprising locking the gauge wheel arm in a second position along the rod without using shims.
